(19) United States
(12) Patent Application Publication
(10) Pub. No.: US 2013/0029062 A1
(43) Pub. Date: Jan. 31, 2013

(54) Scented Artificial Flower

(71) Applicants: Sheil Mehta, Chester, NJ (US); Laxmi C. Mehta, Chester, NJ (US)

(72) Inventors: Sheil Mehta, Chester, NJ (US); Laxmi C. Mehta, Chester, NJ (US)

(73) Assignee: JODHPURI INC., Parsippany, NJ (US)

(21) Appl. No.: 13/191,127

(22) Filed: Jul. 26, 2011

(51) Int. Cl. A41G 1/00; B29D 99/00; B29C 71/02; B29C 67/00; B29C 65/48

(52) U.S. Cl. 428/23; 428/26; 264/319; 156/61

(57) ABSTRACT

Artificial floral products are provided, and more particularly real touch flowers that feel like real flowers and that have an artificial scent associated with the flower are provided. In particular, the scent is embedded into the flower petals, providing a more lifelike appearance and pleasing smell.

### FIELD OF THE INVENTION

The present invention relates to artificial floral products, and more particularly to real touch flowers that look and feel like real flowers, and that have an artificial scent associated with the flower. In particular, the scent is embedded into one or more regions of the flower, including the petals, stem, core, or leaves, providing a more lifelike appearance and smell.

### BACKGROUND OF THE INVENTION

Flowers have long been a symbol of beauty, desired not only for their bright and lively appearance but also for their fresh and pleasant aroma. A single flower is often presented as a gift or used for decoration. In addition, groups of flowers are often used in bouquets or as a centerpiece, due to their beauty. Real flowers, of course, will die after several days of being picked, losing their desired appearance and aroma. Artificial flowers have been used as a long-term replacement for real flowers. Unfortunately, many artificial flowers lack either the lifelike visual appearance, the lifelike touch, or the lifelike aroma associated with real flowers. Attempts to provide artificial flowers having a lifelike aroma have been made, but the vast majority use a scented liquid or gel, which is stored at the base of the flower and is gradually led up the stem of the flower, usually through a plurality of holes, such as that disclosed in U.S. Pat. No. 4,919,981 or U.S. Pat. No. 5,077,102. Attempts have been made using a fan, which blows a scent of a fragrance up through a hollow stem and out the flower, such as U.S. Pat. No. 6,830,733. Other attempts have used gelatin capsules secured at the base of the flower, which is pierced and caused to leak and gradually emit a pleasant aroma, such as in GB 190224797. Unfortunately, these previous attempts not only have a high risk of spilling the scented liquid or gel, but also are not long-lasting, as the scent typically is used up within a matter of days or weeks. In addition, attempts using fans, heating elements, or other similar components use up wasted energy.

There is a need for an artificial, real touch flower having a lifelike aroma embedded into one or more regions of the flower, and which provides a pleasant appearance, feel, and scent to the user for an extended period of time.

### SUMMARY OF THE INVENTION

In one embodiment of the present invention there is provided an artificial floral product having a lifelike look, feel and scent, including: (a) a plurality of molded polymeric petals, where at least one molded polymeric petal includes a mixture of a polymeric material and an oil based fragrance; and (b) optionally, a stem and leaves.

In another embodiment, there is provided a method of forming an artificial flower having a lifelike look, feel and scent, including the steps of: (a) providing at least one polymeric material; (b) melting the at least one polymeric material to form a flower-forming polymeric matrix; (c) introducing an oil-based fragrance to the flower-forming polymeric matrix and mixing the fragrance therein; (d) introducing the mixed flower-forming polymeric matrix into a petal forming mold; (e) cooling the mixed flower-forming polymeric matrix to form a molded petal; and (f) forming an artificial flower from the molded petal; where the oil-based fragrance and the polymeric material are present in a ratio of from about 8:100 to about 12:100 by weight.

### BRIEF DESCRIPTION OF THE FIGURES

Although the present invention may be directed to any desired style of flower, for representative purposes only, the following Figures are provided:

FIG. 1 is a depiction of one embodiment of artificial flower of the present invention.

FIG. 2 is a depiction of another embodiment of artificial flower of the present invention.

### DETAILED DESCRIPTION OF THE INVENTION

The present invention provides an artificial floral product, which has a visually appealing look, feel and scent. In particular, the floral product may be a flower, including petals and a stem. In some embodiments, the floral product may simply be a flower petal or a plurality of flower petals. The artificial floral product is desirably a “real touch” flower, which is a flower that looks like a real flower and feels like a real flower when touched. It will be understood that, as used herein, the terms “artificial” and “real touch” may be used interchangeably and refer to an artificial flower that substantially looks and feels like a real flower. The present invention provides a real touch floral product that smells like a real floral product. It is, of course, understood that users may be able to tell that the floral product is artificial upon closer inspection, but the artificial floral product is substantially lifelike in appearance and feel. The artificial floral product further should have a life span of greater than three months, and more desirably greater than six months. The term “life span” refers to the length of time that the floral product maintains its desired look, feel and/or smell. Thus, the appearance, feel and scent should remain for more than three months or more than six months. In particular, the present invention provides an artificial floral product that avoids the need for a liquid or gel containing reservoir, and avoids the need for components to act as a wick for dispersion of the pleasant aroma. Further, there is no need for moving or electrical parts, such as a fan, a heating element or other similar energy-using component.

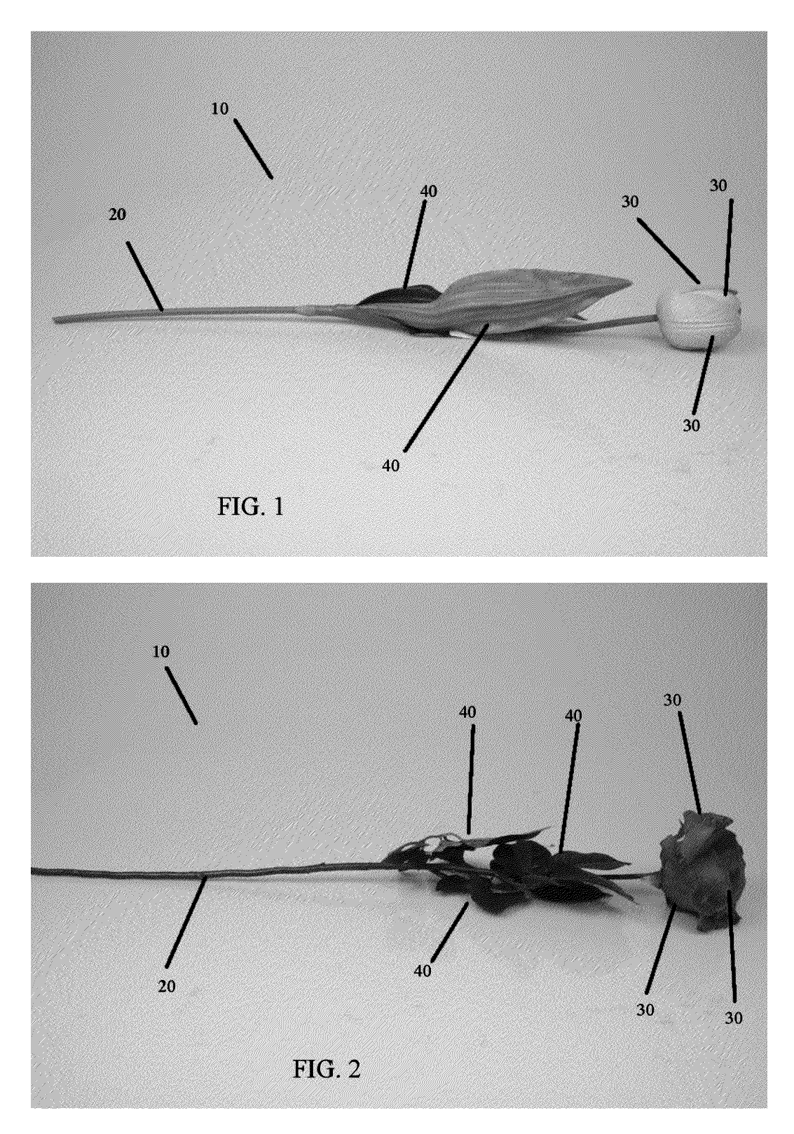

In one embodiment, the invention is directed to an artificial, real touch flower. With reference to the Figures, an artificial flower 10 of the present invention includes a stem 20 and petals 30, and may optionally include any other desired features, such as leaves 40, thorns, buds, or a stamen. For representative purposes only, FIG. 1 represents an artificial tulip, and FIG. 2 represents an artificial rose. The various components of the flower 10 can be seen in these Figures, including the stem 20, petals 30 and leaves 40. In other embodiments, the invention includes an individual scented flower petal or a plurality of scented separate petals, which are not assembled to form a flower. Whether formed into a flower or kept as a plurality of separate petals, the petals of the present invention are desirably made of a flexible polymeric material having a soft and smooth, real touch feel. The stem may also be made from a polymeric material, and may have metallic portions to allow for shaping and bending. Other optional features, including leaves, thorns, stamens, and the like, may be made from any desired material, including a polymeric material. The petals, for example, may be made from a molded piece of polymeric material, where the mold either forms the shape of the petal itself or the mold forms a sheet of polymeric material, from which the petals may be cut. The petals may include shape-forming components embedded in the polymer, such as polymeric or metallic wires, to aid in forming the desired shape.

The real touch flower of the present invention may be any desired flower, including, without limitation: rose, calla lily, tulip, poppy, lily, magnolia, peony, orchid, water lily, Japanese lantern, Chinese lantern, amaryllis, gardenia, lotus, dahlia, hydrangea, daisy, aster, single bud, leaves, and combinations thereof. The shape and look of these particular flowers are known to those of skill in the art. The flower may be a floating flower, which may have a floating material, such as foam, attached thereto. The flower may be part of swag, garland, reeds, or a bouquet, if desired. The flower may be of a size corresponding to a real life flower, or it may be smaller or larger than a real flower. The present invention is not limited to the formation of flowers, and may be used to create other artificial products, including grasses, leaves, and other plants, including trees, their bark and trunks.

The flower 10, and in particular, the petals 30, may desirably be made of a polymeric material, which is soft and malleable when molded. In particular, useful polymers include polyethylene and polyurethane. In one particularly desirable embodiment, the petals are made from a mixture of polyurethane and polyethylene. In such embodiments, it is particularly desired that there be at least as much polyurethane as there is polyethylene (by weight), and more desirably that the polyurethane be present in an amount that is greater than the polyethylene. The ratio of polyethylene to polyurethane is desirably from about 1:1 to about 1:5, by weight of the mixture. More desirably, the ratio of polyethylene to polyurethane is about 1:2.5, measured by weight of the mixture. The polymers may be premade or they may be made in situ during the manufacturing process.

To create a more lifelike flower, the real touch flower desirably includes a fragrance to provide a pleasant scent to the user. In its finished form, the artificial flower should be free of any free flowing liquid or gel fragrance, which may undesirably leak. As will be explained below, the fragrance is mixed with the polymeric material(s) during formation of the flower and is therefore embedded in the molded floral product. It is most desirable that the fragrance match the flower being made, i.e., a rose scent should be used if a rose is being formed; however, the scent may be any desired scent. In fact, the scent used could be a non-floral scent, if such non-floral scents are desired. Any fragrance may be used as desired, and may be oil-based, water-based, and combinations thereof. In preferred embodiments, the fragrance may be an oil-based fragrance, which is liquid at room temperature and which is non-reactive with the polymer or polymers used to form the flower. It is desired that the fragrance be miscible with the polymer or polymers used in the flower, and it is particularly desired that the fragrance be substantially non-reactive with the polymer(s) used. The fragrance may be generally hydrophilic in nature, to allow it to be miscible with the polymer or polymers used. The fragrance may be a blend of various components, including both natural and synthetic organic molecules, and may include, for example, alcohols, esters, ketones, aldehydes, ethers, amides, terpines and derivatives thereof, essential oils, and combinations thereof. The fragrance may optionally be combined with one or more binders or solvents known in the art.

It is important to the present invention that the fragrant flower have a scent that is noticeable, but not overpowering. In addition, it is important that the molded petal 30, which includes a blended mixture of polymeric material and fragrance, be capable of forming a suitable flower having lifelike feel and appearance without leaking, cracking or breaking For these reasons, the relative amounts of fragrance and polymeric materials should be within a desired range. The present applicants have conducted substantial testing and found that a particular ratio of polymeric materials to oil-based fragrance provides the desired result. In particular, it was discovered that the desirable level of fragrance to polymeric materials is from about 8:100 to about 12:100 by weight, and more desirably about 1:10 by weight. Less fragrance results in a product that has an unsuitable scent level, and more fragrance results in a product that either has an inadequate look or feel, or simply deteriorates and cannot form a molded product.

The flower 10 may include one or more colors, to provide a visually appealing look. The color used should desirably match the color of the flower as it is found in real life, but any color or combinations of colors may be used as desired. For example, the finished flower 10 may include a plurality of colors, which may or may not correspond to any color of real flowers. The color is formed through the use of one or more dyes, which may be incorporated into the flower-forming matrix or may be applied after the flower has been formed. Thus, in one embodiment, the finished flower 10 has petals 30 made from a polymeric material, which has a fragrance and a color embedded therein. In another embodiment, the finished flower 10 has petals 30 made from a polymeric material that has a fragrance embedded therein, and a color provided on at least one surface of the finished flower petal 30.

A method of forming the artificial flower of the present invention is provided. The polymer or polymers used are first provided. Desirably, the polymer includes polyurethane, polyethylene, and combinations thereof. Optionally, the polymer or polymers used may be polymerized in situ during the manufacturing process. Desirably, however, the polymer or polymers are already prepared prior to the manufacturing process. The polymer material (or materials) is first melted to form a flower-forming polymeric matrix. As used herein, the term “matrix” is used to refer to a free flowing, melted polymer material, which may optionally include additives. The melting is desirably achieved through the application of heat to the polymer(s), such as in a vat or in an oven. Once melted, the temperature should remain sufficiently high to maintain the polymer in its melted form until the polymeric material is used to form the flower, i.e., until the polymeric material is introduced into a suitable mold. The temperature should not be so high that it will drive off solvents, additives, or fragrances added to the matrix. In some embodiments, the melting temperature is about 1 to about 20 degrees higher than the highest melting point of the polymers used, and desirably about 1 to about 10 degrees higher than the highest melting point of the polymers used. Fillers, colors, or other additives may be added to the polymeric mixture, if desired.

In preferred embodiments, a fragrance and/or color may be mixed with the flower-forming polymeric matrix before molding the polymeric matrix. Any desired fragrances may then be mixed along with the molten polymeric material or materials. Most desirably, the fragrance is an oil-based fragrance having a pleasing aroma. As explained above, the oil-based fragrance may be hydrophilic and may include various combinations of components. Use of a hydrophilic fragrance may be desired so that the fragrance may act as a plasticizer to the polymer or polymers used in the flower, thereby softening the resulting flower and allowing it to have a more life-like look, feel and texture.

It may be particularly desired that the fragrance has a scent that substantially matches the scent of the flower being formed (i.e., a rose may have a rose-like aroma). Of course, the fragrance used does not necessarily have to match the flower being formed. In addition, some flowers may not have a scent, and thus the artificial, real touch flower of the present invention may have a scent even though the flower does not have a scent. In addition, the scent may not be a floral scent, and my simply be a pleasing aroma. Other scents may be used, including non-floral scents, depending upon the desired aroma. Further, the scent may be an odor eliminating scent, not limited to a floral scent. If desired, dyes or other color forming materials may be introduced into the polymer matrix, as well.

As explained above, the finished flower 10 should have a suitable feel, appearance and smell, and thus the particular amounts of fragrance and polymeric material(s) may be important. It has been found that too low or too high an amount of fragrance as compared to the polymeric material(s) may result in an unacceptable end product. For example, if the amount of fragrance is too low or too high, the resulting product may not look or feel life-like, may have leaks, may have cracks, or may be too sticky. The present applicants have found that the desirable level of fragrance to polymeric materials is from about 8:100 to about 12:100 (w/w), and more desirably about 1:10 by weight. Any amount of coloring material, such as a dye, may be used to form the desired color. Alternatively, the flower-forming polymeric matrix may be void of any coloring materials.

Once the flower forming matrix has been formed, the matrix may be formed into a flower petal forming mold, forming the flower petal. The flower petal forming mold may be a mold that takes the shape of the desired flower petal, or alternatively, the mold may simply form a rectangular or square sheet, from which at least one individual petal may be cut. The mold is desirably made of aluminum, but any sturdy and desirable material may be used. Any petal shape may be formed as desired, depending upon the desired flower type. For example, the mold shape for the petal may be that of a rose petal, or a lily petal, or any other desired petal shape.

A polymeric or metallic wire or other malleable material may be embedded into the petal, allowing the petal to be shaped as desired after formation. The shape and look of a flower petal will be known to those of skill in the art, and any desired flower petal may be used, including petals for the flowers set forth above. In general, a desirable flower petal has a length of from about 1 inch to about 15 inches, a width of from about 5 inches to about 15 inches, with a thickness of less than 0.5 inches, more desirably less than 0.1 inches. Individual petals may be formed in individual molds and then adhered together, or alternatively, an arrangement of petals forming the shape of the desired flower may be formed in a single mold. For example, a rose-shaped mold may be used, which allows the flower-forming matrix to fully form a cohesive rose shaped product.

In some embodiments, the petals may be formed by first forming a sheet of molded polymeric material having the desired thickness, and subsequently cutting flower petals using a cutting tool. Any size sheet of molded material may be used, and in preferred embodiments, the sheet is large enough to allow for cutting of a plurality of flower petals therefrom. After each individual flower petal is cut to the desired size, the petals can be joined together to form the resulting flower, such as through the use of an adhesive. The petals may be shaped, bent, or flexed after they are formed, to form the desired shape. The sheet of polymeric material may be colored before formation (i.e., with a dye mixed into the molten flower-forming polymeric matrix), or it may be colored after formation, such as through hand painting or spray painting. In some embodiments, the petals may be colored after they are cut to the desired shape and size.

Once the flower-forming polymeric matrix is introduced into the desired mold, whether the mold is an individual petal, a mold in the shape of a plurality of petals forming the flower, or a sheet from which the petals will be cut, the mold is allowed to cool to a sufficient temperature to solidify the scented polymeric matrix. Once the polymeric matrix is sufficiently cooled, for example, to room temperature or below, the molded materials may be removed and used.

In addition to the formation of the petals, other flower components may be formed. For example, a stem 20 and optional leaves 40, thorns or stamen may be formed. The stem 20 and/or leaves 40, thorns or stamen may be formed from a similar polymeric material as the petals 30, or they may be formed from a different polymeric material. It is preferred that the stem 20 and/or leaves 40 be colored green, so as to have a lifelike appearance. The stem 20 and/or leaves 30, thorns or stamen may be formed from a similar molding process as the petals, and may optionally include a fragrance mixed into the polymeric matrix, as explained above. The leaves may optionally be formed through cutting a sheet of formed polymeric material, as described above, or individual leaf molds may be used to form leaves individually. The stem may include a shape forming material, such as a wire, plastic, or other deformable or malleable material, to provide shape and strength to the resulting flower. The stem 20 and leaves 40 may be formed from a single unitary mold, or they may be formed as separate components. Optional thorns and/or stamen may be provided, which may be polymeric in nature, and may be adhered to the flower. In one embodiment, the stem is formed in a mold that includes regions forming thorns, where the stem and thorns are from one unitary molded piece.

In general, a desirable stem 20 is substantially cylindrical in shape, and has a length of about 1 inch to about 50 inches and a diameter of from about ⅛ inch to about 3 inches. In general, a desirable leaf 40 has a length of about 1 inch to about 10 inches, a width of from about 1 inch to about 10 inches, and a thickness of less than 0.5 inches, and more desirably less than 0.1 inches. The sizes and shapes of the stem, leaves, and the petals may vary as desired, depending upon the size of the flower desired, as well as whether the flower will be used in a bouquet or other arrangement.

In some embodiments, the entire flower may be formed from a single unitary mold, or the individual components may be formed separately. In embodiments where the entire flower is formed from one unitary mold, it is desired that the flower-forming polymeric material be void of coloring materials, allowing the finished flower to be colored after formation. In embodiments where the components are formed separately, the components may be attached via any desired means, including, for example, use of an adhesive. Thus, the various components, including petals 30, stem 20, leaves 40, thorns and stamen, may be formed separately or they may be formed together in a single mold. Alternatively, the petals 30 may be formed from one mold or sheet, and the stem 20 and leaves 40 may be separately formed from another mold. In some embodiments, the petals 30 and stem 20 may be formed from one mold and the leaves 40 formed from a separate mold. In embodiments where the petals 30 and the stem 20 are formed from one mold, it is desirable that the polymeric flower-forming matrix be free of coloring materials, to allow for subsequent coloring after formation of the molded flower.

After the polymeric flower forming matrix is inserted into the mold or molds, it is allowed to cool and harden, taking the shape of the mold. After the polymeric material has sufficiently hardened, the resulting flower may be removed from the mold or molds. If the flower is formed in separate molds, the various components may be adhered together. If the petals or leaves are to be cut from a molded sheet, the petals and/or leaves may then be cut to the desired size and shape. Optionally, the components may be colored after formation, either before or after adhering the components together. Of course, the polymeric matrix forming the flower components may include a colorant prior to molding.

The various components of the flower 10 (i.e., petals 30, stem 20, and optional leaves 40, thorns and stamen) may be colored before formation in the mold, or they may be colored after formation in the mold. For example, a dye or dyes may be incorporated into the flower-forming polymeric matrix after it is melted, prior to forming in the mold. Thus, the resulting molded flower is colored. In some embodiments, however, the coloring is achieved after the individual components of the flower are formed. For example, one or more components may be molded as an uncolored material and colored after formation. As used herein, the term “uncolored” refers to a material that does not have the final desired color, and is not intended to refer to a clear or colorless material.

An uncolored material, after it is formed in a mold and/or cut from a sheet of molded material, may be colored through any desired means. For example, the desired color or colors may be sprayed on to one or more surfaces of the components, or the component(s) may be dipped into a coloring material. In some embodiments, the color(s) may be hand painted onto one or more surfaces, or alternatively may be highlighted onto one or more surfaces. The individual components may include more than one color on any given surface. For example, the leaves may have a background color of green, while the tips of the leaves have a yellow color. The petals may have a plurality of colors painted onto their respective surfaces. In some embodiments, a first coloring material (i.e., a dye) is incorporated into the flower forming polymeric matrix and a molded petal is formed, and then a second coloring material is used to color at least a portion of a surface of the petal. The first and second coloring materials may be the same or they may be different.

In embodiments where at least two flower components are formed separately, once the coloring step has been performed, it may be desired to adhere the components of the flower together, forming the finished flower product. For example, in one embodiment, uncolored petals, stem and leaves may be formed from separate molds (or cut from molded sheets). Once the polymeric material has dried, the individual components may be colored through spray painting or hand painting on the surfaces. Once the paint has sufficiently dried, the petals, stem and leaves may be adhered together to form a desired flower.

Optionally, there may be a coating applied to the outer surface of one or more components. The coating may provide any desired effect to the surface, including a metallic coating, shiny coating, glitter coating, painted coating, glossy coating, rough coating, soft coating or flocked coating.

Once the final floral product or floral products have been formed, optionally cut, optionally colored and optionally adhered, the product or products may be packaged and sold. In some embodiments, a single flower is sold by itself. In other embodiments, a group of flowers, such as a bouquet, may be packaged and sold together. In some embodiments, a plurality of separate flower petals may be packaged and sold as a free collection of petals.

In some embodiments, a flower, or collection of flowers, may be provided with optional accessories, such as faux water, artificial soil, or other additional components to provide a more life-like product. A product may include, for example, at least one real touch flower of the present invention, a vase and faux water. Other additional components may be included, such as grasses, branches, soil, ribbons, and other decorative add-ons.

Further, in some embodiments, the inventive flower or flowers may be combined with other flowers to prepare an arrangement or decoration. For example, an inventive flower (or flowers) may be combined with real flowers, silk flowers, dried flowers, beaded flowers, and the like, to prepare a final product. The final product assembly may include a combination of inventive, scented real touch flowers and other flowers, including silk flowers, dried flowers, freshly cut flowers and combinations thereof.

The resulting product, whether it is an artificial flower 10, a collection of artificial flowers 10, or plurality of separate petals 30, has a look that resembles a real flower, a feel that resembles a real flower, and a scent that is pleasing to the user. The scent need not necessarily be a floral scent, but it may be floral in nature. The resulting product is desirably a real touch flower having a scent embedded into at least one component of the flower. As explained above, the resulting product is preferably free of any free flowing gels or liquids to provide the scent; rather the scent is embedded into the polymeric matrix forming the at least one component of the flower. The scent desirably is not overpowering to the user, and has a retention time of at least three to six months, and in some embodiments at least six months. The various materials used, including the polymeric materials, colors, and fragrances, should be compatible with each other.

The present invention is not limited to flowers and various components of flowers (i.e., petals, stem, core, leaves), and it may be used to prepare other products, such as grass, leaves, sticks, trees, bark, or other plants or plant-life. Each of these products may be scented as explained above, and may include the same scent or different scents. The present invention may be used to prepare, for example, an artificial garden or nature scene, which includes flowers, grass, bushes, and the like.

### EXAMPLES

The present applicants have conducted experiments to determine the optimal amount of fragrance and polymeric material(s) in flower formation. Various flowers were made using different ratios of a hydrophilic, oil-based fragrance and polymeric materials. The polymeric materials used were a mixture of polyethylene and polyurethane in a ratio of about 1:2.5 by weight (polyethylene to polyurethane). The polymeric materials were melted and mixed with the fragrance, provided into a mold and cooled. The samples were then tested for smell, look and feel. The results are provided in Table 1 below:

TABLE 1
results of testing

| | | | Polymeric | |
|---|---|---|---|---|
| | Fragrance | | materials | |
| Flower Type | amount | | amount | Result |
| Rose open | 5.0 | g | 100 g | Fragrance was too light |
| | | | | to be smelled |
| Rose open | 7.5 | g | 100 g | Fragrance was able to be |
| | | | | smelled, but too light |
| Rose open | 10.0 | g | 100 g | Desired fragrance level; |
| | | | | desired look and feel |
| Rose open | 15.0 | g | 100 g | Sample was deteriorated; |
| | | | | unusable |
| Rose bud | 5.0 | g | 100 g | Fragrance was too light |
| | | | | to be smelled |
| Rose bud | 7.5 | g | 100 g | Fragrance was able to be |
| | | | | smelled, but too light |
| Rose bud | 10.0 | g | 100 g | Desired fragrance level; |
| | | | | desired look and feel |
| Rose bud | 15.0 | g | 100 g | Sample was deteriorated; |
| | | | | unusable |
| Peony | 3.0 | | 100 g | Fragrance was too light |
| | | | | to be smelled |
| Peony | 5.0 | g | 100 g | Fragrance was too light |
| | | | | to be smelled |
| Peony | 7.0 | g | 100 g | Fragrance was present |
| | | | | but not strong enough |
| Peony | 10.0 | g | 100 g | Desired fragrance level; |
| | | | | desired look and feel |

As can be seen, for each of the samples prepared, the oil-based fragrance being present in an amount of about 10 grams, while the polymeric materials were present in an amount of about 100 grams, provided a sample that had an adequate smell, feel and look. Samples including too little or too high fragrance amount provided undesirable products. Based upon the test data, it was determined that a ratio of about 1:10 fragrance to polymeric materials provides a suitable real touch product, having the desired feel, look and smell.

What is claimed is:

1. An artificial floral product having a lifelike look, feel and scent, comprising:
(a) a plurality of molded polymeric petals, wherein at least one molded polymeric petal comprises a mixture of a polymeric material and an oil based fragrance; and
(b) optionally, a stem and leaves.

2. The artificial floral product of claim 1, wherein said polymeric material comprises a polymer selected from the group consisting of: polyethylene, polyurethane, and combinations thereof

3. The artificial floral product of claim 2, wherein said polymeric material comprises a mixture of polyurethane and polyethylene.

4. The artificial floral product of claim 3, wherein said mixture comprises a ratio of polyethylene to polyurethane of from about 1:1 to about 1:5 by weight.

5. The artificial floral product of claim 3, wherein said mixture comprises a ratio of polyethylene to polyurethane of about 1:2.5 by weight.

6. The artificial floral product of claim 1, wherein said oil based fragrance and said polymeric material are present in a ratio of from about 8:100 to about 12:100 by weight.

7. The artificial floral product of claim 6, wherein said oil based fragrance and said polymeric material are present in a ratio of about 1:10 by weight.

8. The artificial floral product of claim 1, wherein each of said molded polymeric petals is formed in a single mold.

9. The artificial floral product of claim 1, wherein each of said molded polymeric petals is formed from a sheet of polymeric material.

10. The artificial floral product of claim 9, wherein each of said molded polymeric petals is individually cut from said sheet of polymeric material.

11. The artificial floral product of claim 1, wherein said floral product is a flower selected from the group consisting of: rose, calla lily, tulip, poppy, lily, magnolia, peony, orchid, water lily, Japanese lantern, Chinese lantern, amaryllis, gardenia, lotus, dahlia, hydrangea, daisy, aster, and single bud.

12. A bouquet formed from a plurality of artificial floral products of claim 1.

13. A method of forming an artificial flower having a lifelike look, feel and scent, comprising the steps of:
(a) providing at least one polymeric material;
(b) melting said at least one polymeric material to form a flower-forming polymeric matrix;
(c) introducing an oil-based fragrance to the flower-forming polymeric matrix and mixing the fragrance therein;
(d) introducing said mixed flower-forming polymeric matrix into a petal forming mold;
(e) cooling said mixed flower-forming polymeric matrix to form a molded petal; and
(f) forming an artificial flower from said molded petal;
wherein said oil-based fragrance and said polymeric material are present in a ratio of from about 8:100 to about 12:100 by weight.

14. The method of claim 13, wherein said oil-based fragrance and said polymeric material are present in a ratio of about 1:10 by weight.

15. The method of claim 13, wherein said petal forming mold is shaped like a flower petal.

16. The method of claim 13, wherein said petal forming mold is substantially flat and at least one molded petal is cut from said substantially flat molded polymer.

17. The method of claim 13, wherein said polymeric material comprises a polymer selected from the group consisting of: polyethylene, polyurethane, and combinations thereof.

18. The method of claim 17, wherein said polymeric material comprises a mixture of polyurethane and polyethylene.

19. The method of claim 18, wherein said mixture comprises a ratio of polyethylene to polyurethane of from about 1:1 to about 1:5 by weight.

20. The method of claim 19, wherein said mixture comprises a ratio of polyethylene to polyurethane of about 1:2.5 by weight.

21. The method of claim 13, wherein said flower is selected from the group consisting of a rose, calla lily, tulip, poppy, lily, magnolia, peony, orchid, water lily, Japanese lantern, Chinese lantern, amaryllis, gardenia, lotus, dahlia, hydrangea, daisy, aster, and single bud.

22. The method of claim 13, further comprising the step of forming a plurality of artificial flowers.

23. The method of claim 22, further comprising a step of arranging said plurality of artificial flowers into a bouquet.

24. The method of claim 13, further comprising the step of providing a polymeric stem.

25. The method of claim 24, wherein said polymeric stem is adhered to said molded petal.
